(19) United States
(12) Patent Application Publication
(10) Pub. No.: US 2009/0265318 A1
(43) Pub. Date: Oct. 22, 2009

(54) Port Location Determination for Wired Intelligent Terminals

(75) Inventor: Vincent F. Vermeulen, Newbury Park, CA (US)

Correspondence Address: Law Office of WILLIAM J. TUCKER, 2631 Lakeforest Ct., Dallas, TX, 75214, US

(73) Assignee: Alcatel Lucent, Paris (FR)

(21) Appl. No.: 12/106,961

(22) Filed: Apr. 21, 2008

(51) Int. Cl. G06F 15/16; G06F 17/30; G06F 7/06

(52) U.S. Cl. 707/3; 707/100; 709/204; 707/E17.044; 707/E17.014

(57) ABSTRACT

Locations corresponding to ports of a wired intelligent terminal may be determined. In an example embodiment, an intelligent terminal includes multiple ports, a location association data structure, and a location association handler. The multiple ports provide ingress and egress for communications being received at and transmitted from the intelligent terminal. The location association data structure includes multiple entries with each corresponding to a respective port. Each entry associates a port identification of the corresponding respective port with a location indication. The location association handler ascertains a port on which a location information communication is received from a location indicating device that is coupled to a remote termination point. The location information communication includes a particular location indication that is ascertained at the location indicating device. The location association handler stores the particular location indication in association with a port identification of the ascertained port in the location association data structure.

### BACKGROUND

Much of today's communication occurs over networks. Networks include telecommunications networks, computer networks, combinations of such networks, and so forth. Networks may be formed from wired technologies, wireless technologies, or both. Typically, a communication originates at one end device that is coupled to a network, traverses one or more network devices of the network, and then terminates at another end device that is also coupled to the network. Communications may also originate or terminate within the network itself.

The operation and maintenance of networks and the successful completion of a communication may be impacted by the locations of network devices and/or end devices. For example, some communication features operate responsive to the location from which a message originates. Also, the diagnosis of network failures can often be expedited or otherwise facilitated with adequate network-related location information. Unfortunately, existing approaches for determining network-related locations result in untrustworthy data, require significant network infrastructure, rely on transient information, or have other drawbacks.

### SUMMARY

Locations corresponding to ports of a wired intelligent terminal may be determined. In an example embodiment, an intelligent terminal device includes multiple ports, a location association data structure, and a location association handler. The multiple ports provide points of ingress and egress for communications being received at and transmitted from the intelligent terminal device. The location association data structure includes multiple entries with each entry corresponding to a respective port. Each entry associates a port identification of the corresponding respective port with a location indication.

The location association handler ascertains a port on which a location information communication is received from a location indicating device that is coupled to a remote termination point. The location information communication includes a particular location indication that is ascertained at the location indicating device. The location association handler stores the particular location indication in association with a port identification of the ascertained port in the location association data structure at an entry that corresponds to the ascertained port. Moreover, other systems, methods, devices, media, apparatuses, arrangements, and other example embodiments are described herein.

### BRIEF DESCRIPTION OF THE DRAWINGS

The same numbers are used throughout the drawings to reference like and/or corresponding aspects, features, and components.

FIG. 1 is a block diagram of an example port location determination environment including an intelligent terminal and a location indicating device.

FIG. 2 is a block diagram that illustrates an example port location determination procedure that includes a location information communication having a location indication.

FIGS. 2A and 2B are block diagrams illustrating first and second example embodiments, respectively, of an intelligent terminal.

FIG. 3 is a flow diagram that illustrates an example of a general method for port location determination that may be implemented by a location indicating device.

FIG. 4 is a flow diagram that illustrates an example of a general method for port location determination that may be implemented by an intelligent terminal.

FIG. 5 is a block diagram of an example communication format for a location information communication having a location indication.

FIGS. 6A and 6B are a block diagram illustrating an example scheme and a flow diagram illustrating an example method, respectively, for management system integration embodiments.

FIGS. 7A and 7B are a block diagram illustrating an example scheme and a flow diagram illustrating an example method, respectively, for end device location-indication-acquisition embodiments.

FIG. 8 is a block diagram of example devices that may be used to implement embodiments for port location determination.

### DETAILED DESCRIPTION

For certain types of communications and/or for network maintenance operations, the originating or terminating location of a communication can be used to enhance transmission or routing, to provide specialized services, to diagnose network issues, and so forth. However, determining a location of a network component can be difficult because networks can be complicated mazes of many different devices and cables. Moreover, network components, especially cabling, may be positioned out of view.

In general, a wired network may be built within a building, throughout a neighborhood, or over much vaster distances. Wired networks usually include many network components that are interconnected by cabling. The endpoints of the cabling are often referred to as remote termination points (RTPs). It is difficult and time consuming to manually manage the myriad of paths of cabling between RTPs and the network components to which they are connected.

Many network components include ports that enable the connection of cabling thereto. The interconnected cabling and network components create the backbone of a network to enable communication, but they also create a web-like maze of snaking cables that are difficult to manually trace. Automated location determination for some network components, such as ports, can mitigate the difficulties inherent with manual management. However, there are no known conventional approaches that adequately facilitate automated location determinations with respect to ports.

Generally, an example embodiment entails ascertaining a location indication at an RTP using a location indicating device that is coupled to the RTP. This location indication is transmitted from the location indicating device over cables or cabling to an intelligent terminal via a port thereof. The intelligent terminal stores the location indication in association with an identification of the port in a location association data structure at the intelligent terminal. This creates a known correspondence between a port in the network and a location of an RTP. The location of the endpoint of cabling that is coupled to a port of an intelligent terminal can then be retrieved by the network as desired. In this example manner, the originating or terminating location for a communication is determinable based on the port through which the communication is received or transmitted, respectively.

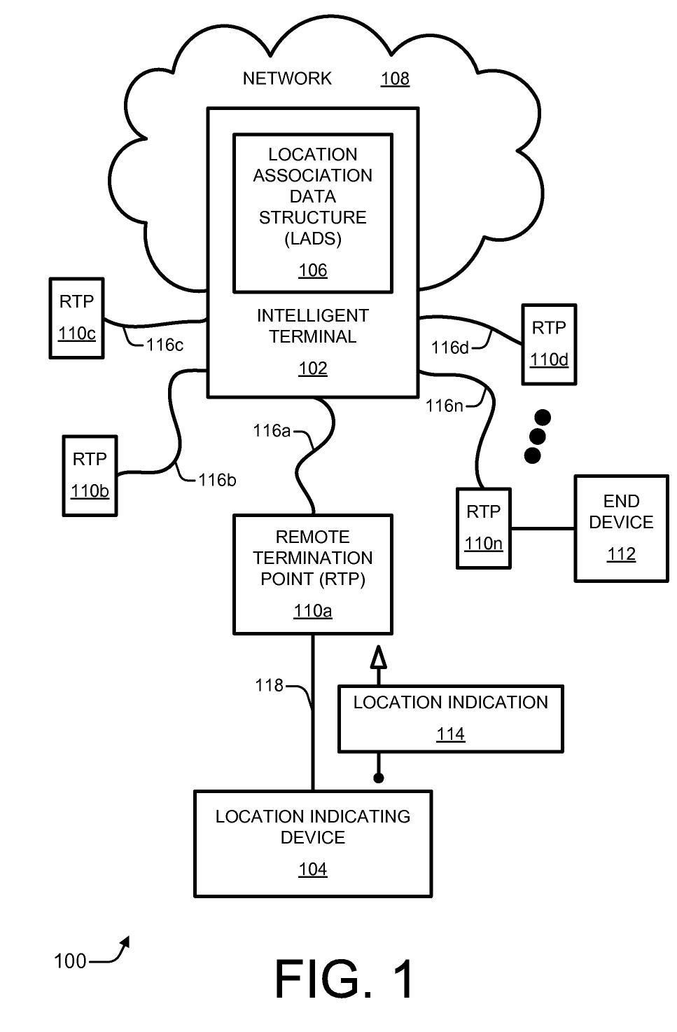

FIG. 1 is a block diagram of an example port location determination environment 100 including an intelligent terminal 102 and a location indicating device 104. As illustrated, environment 100 also includes a location association data structure (LADS) 106 as part of intelligent terminal 102, network 108, multiple RTPs 110, an end device 112, a location indication 114, and multiple cables/cabling. Specifically, “n” RTPs 110 are shown: 110a, 110b, 110c, 110d . . . 110n, with “n” representing some positive integer.

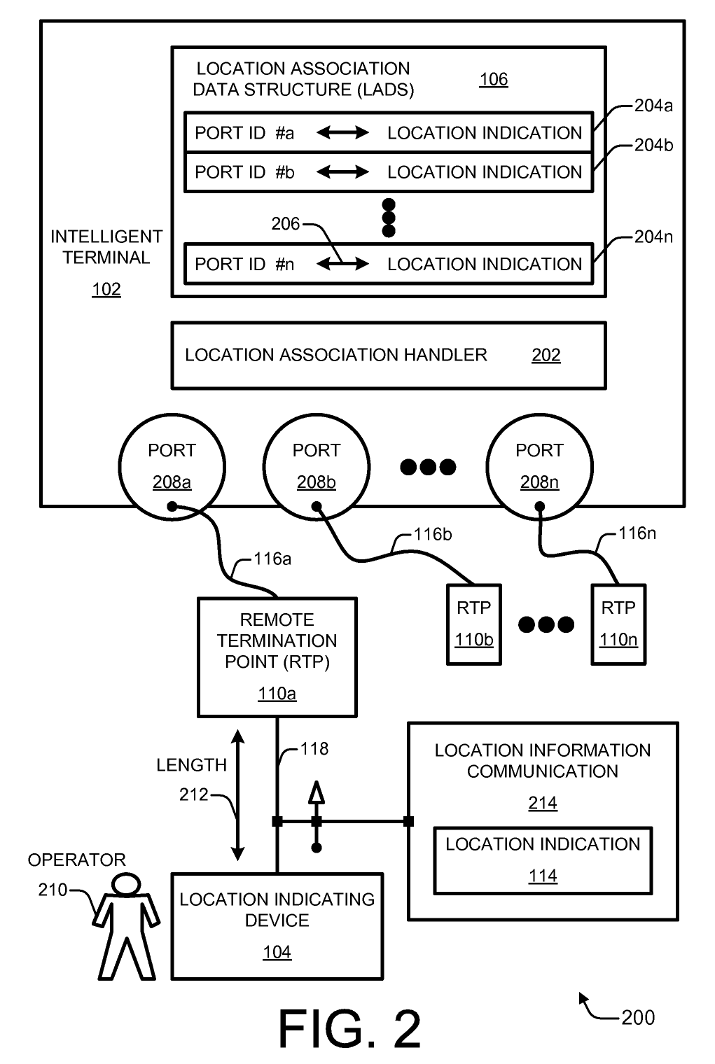

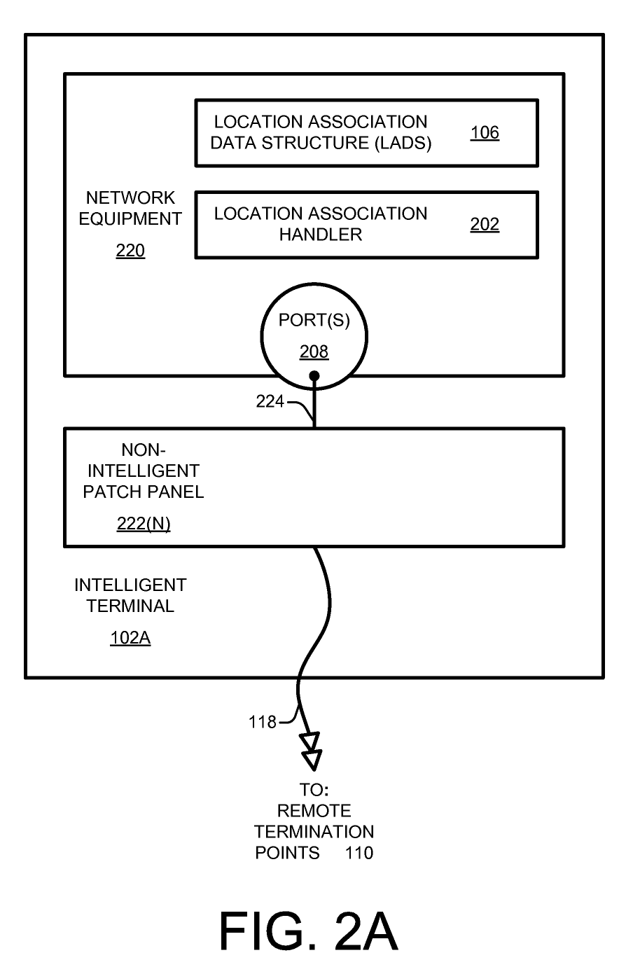

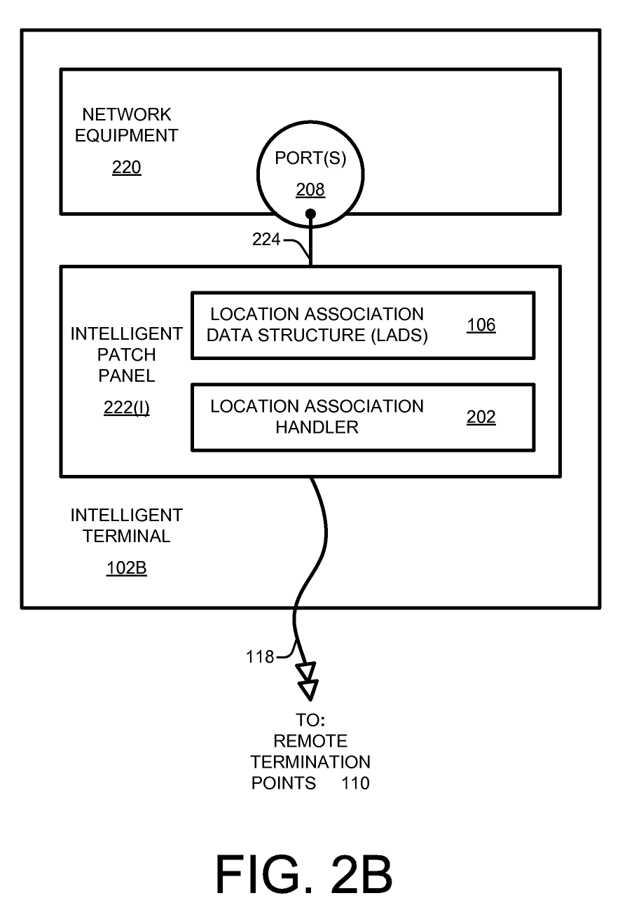

In an example embodiment, network 108 includes one or more intelligent terminals 102. Each intelligent terminal 102 may include at least one location association data structure 106. Example embodiments for location association data structure 106 and intelligent terminals 102 are described further herein below with particular reference to FIGS. 2 and 2A/2B. Each RTP 110a-n is coupled to intelligent terminal 102 via at least one respective cabling 116a-n. End device 112 is shown coupled to RTP 110n. Each RTP 110 may comprise a jack, a cabling endpoint, some combination thereof, and so forth.

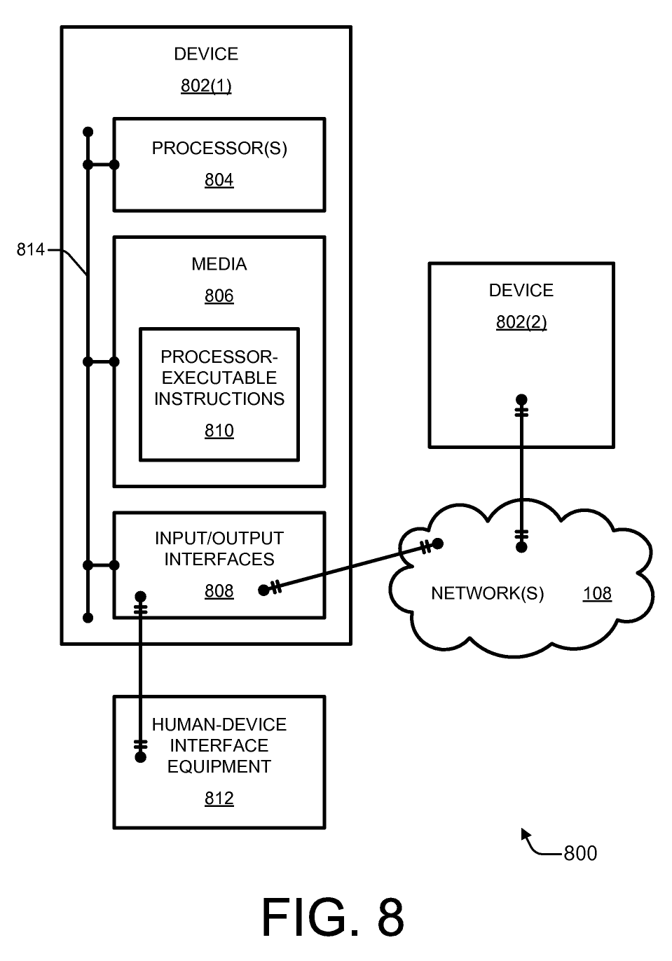

In an example operation, location indicating device 104 is coupled to RTP 110a via at least one patch cable 118. Location indicating device 104 ascertains its current location. This current location is transmitted as location indication 114 to intelligent terminal 102 over patch cable 118 and cabling 116a via RTP 110a. Intelligent terminal 102 stores location indication 114 at location association data structure 106. An example organization for location association data structure 106 is described herein below with particular reference to FIG. 2. Example implementations for devices such as intelligent terminal 102 and location indicating device 104 are described herein below with particular reference to FIG. 8.

Location indicating device 104 may be any device that is capable of being coupled to RTP 110a via patch cable 118 and that is also capable of ascertaining its current location. Location indicating device 104 may be a specialized or a general-purpose device. Examples include, but are not limited to: a notebook, ultraportable, handheld, or other computer; a device including an integrated global positioning system (GPS) functionality; a personal digital assistant (PDA) or a mobile phone; combinations thereof, and so forth. Also, a specialized location indicating device 104 may be designed to ascertain a current location and provide it to intelligent terminal 102. A location indicating device 104 may provide audible and/or visual output to an operator and enable manual input or activation by the operator.

Location indication 114 may comprise automatically ascertained location information and/or manually-input location information. Hence, a location indicating device 104 may include at least one electronic mechanism for ascertaining a location indication 114 autonomously. Location indicating device 104 may include at least one manual input mechanism (e.g., a keyboard, keypad, touch screen, etc.) for ascertaining a location indication 114 from an operator's input. Examples for location indications include, but are not limited to: geographical information, building information (e.g., building name, floor, wing, room, cubicle, etc.), jack identifier (e.g., number or alphanumeric indicator), elevation, emergency location information number (ELIN) for E911 services, a specific description, some combination thereof, and so forth. Geographical information (e.g., longitude, latitude, other coordinates, etc.) may be ascertained using, for instance, a satellite-based system (e.g., GPS), triangulation with multiple stations (e.g., three wireless nodes), and so forth.

FIG. 2 is a block diagram that illustrates an example port location determination procedure 200 that includes a location information communication 214 having a location indication 114. As illustrated, procedure 200 also includes an operator 210. Intelligent terminal 102 further includes a location association handler 202 and multiple ports 208. Specifically, “n” ports 208 are shown: 208a, 208b . . . 208n. RTPs 110a,b,n are respectively coupled to ports 208a,b,n over cabling 116a,b,n. Although the number of each is denoted by “n”, there may be different numbers of RTPs 110 and ports 208.

In an example embodiment, operator 210 connects location indicating device 104 to RTP 110a via patch cable 118. Location indicating device 104 ascertains a current location, which is represented by location indication 114. Location indicating device 104 formulates location information communication 214, which includes location indication 114. Location indicating device 104 transmits location information communication 214 to port 208a of intelligent terminal 102 over patch cable 118 and cabling 116 via RTP 110a.

Intelligent terminal 102 receives location information communication 214 from location indicating device 104 via port 208a. Each port 208 provides a point of ingress and egress for communications being received at and transmitted from intelligent terminal 102. Intelligent terminal 102 includes location association handler 202 and location association data structure 106. With regard to certain aspects of described port location determination embodiments, location association handler 202 may perform the functions that are described herein. Location association handler 202 may be realized as software, firmware, hardware, fixed logic circuitry, some combination thereof, and so forth.

In an example embodiment, location association data structure 106 includes multiple entries 204. Specifically, it may include “n” entries 204a, 204b . . . 204n that respectively correspond to the “n” ports 208a, 208b . . . 208n of intelligent terminal 102. Each entry 204 associates at 206 a port identification (ID) with a location indication. Specifically, each entry 204a, 204b . . . 204n includes a respective port ID #a, #b . . . #n or otherwise corresponds to a respective port ID #a, #b . . . #n. Hence, it should be understood that each entry 204 may correspond to a respective port or port ID without literally storing the value of the port ID within the entry.

Thus, each respective entry 204 associates a respective port ID with a respective location indication. The location indication included in the respective entry 204 comprises a location indication 114 that arrived via the corresponding port 208 as identified by the port ID. Although shown as having “n” entries 204, location association data structure 106 may alternatively have more or fewer than “n” entries 204.

Continuing with the example operation, intelligent terminal 102 receives location information communication 214 from location indicating device 104 via port 208a. Location association handler 202 extracts location indication 114 from location information communication 214. Location association handler 202 is adapted to ascertain that location information communication 214 arrives or is received via port 208a. In response to receiving location information communication 214 via port 208a, location association handler 202 accesses location association data structure 106 at an entry 204a corresponding to port 208a. At entry 204a, location association handler 202 stores the received location indication 114 in association 206 with a port ID #a, which is an identification of port 208a.

As shown, patch cable 118 has a length 212. Location indication 114 may comprise a current location that is ascertained using a positional approach. In other words, location indication 114 may be ascertained by location indicating device 104 using a satellite-based system, using a triangulation with multiple wireless nodes, and so forth. When a positional location approach is used, the accuracy of location indication 114 with respect to conveying the location of RTP 110a is increased as length 212 is decreased. Length 212 may be controlled by operator 210 or a system administrator. Moreover, regardless of length 212, operator 210 may hold, place, or otherwise dispose location indicating device 104 as near to RTP 110a as is practical during the positional location ascertainment for the sake of increased accuracy.

FIGS. 2A and 2B are block diagrams illustrating first and second examples, respectively, of intelligent terminal embodiments. First intelligent terminal example 102A includes network equipment 220 and a non-intelligent patch panel 222(N). Second intelligent terminal example 102B includes network equipment 220 and an intelligent patch panel 222(I).

For both intelligent terminals 102A and 102B, network equipment 220 includes one or more ports 208, as represented by port 208. Network equipment 220 may be, for example, a switch, a router, some combination thereof, and so forth. Generally, a patch panel 222 collects the cabling 118 from multiple RTPs 110. Individual respective patch cables 224 connect patch panel 222 to individual respective ports 208 of network equipment 220. However, patch panels 222 and patch cables 224 may be implemented in alternative manners.

In an example embodiment for intelligent terminal 102A, location association data structure 106 and location association handler 202 are disposed in and implemented by network equipment 220. In an example embodiment for intelligent terminal 102B, location association data structure 106 and location association handler 202 are disposed in and implemented by intelligent patch panel 222(I). Thus, at least with respect to intelligent terminal 102, the functionality of port location determination procedure 200 is effectuated at network equipment 220 for intelligent terminal 102A and is effectuated at intelligent patch panel 222(I) for intelligent terminal 102B. Intelligent terminals 102 may be implemented as, for example, managed Ethernet switches that are Layer-2 aware.

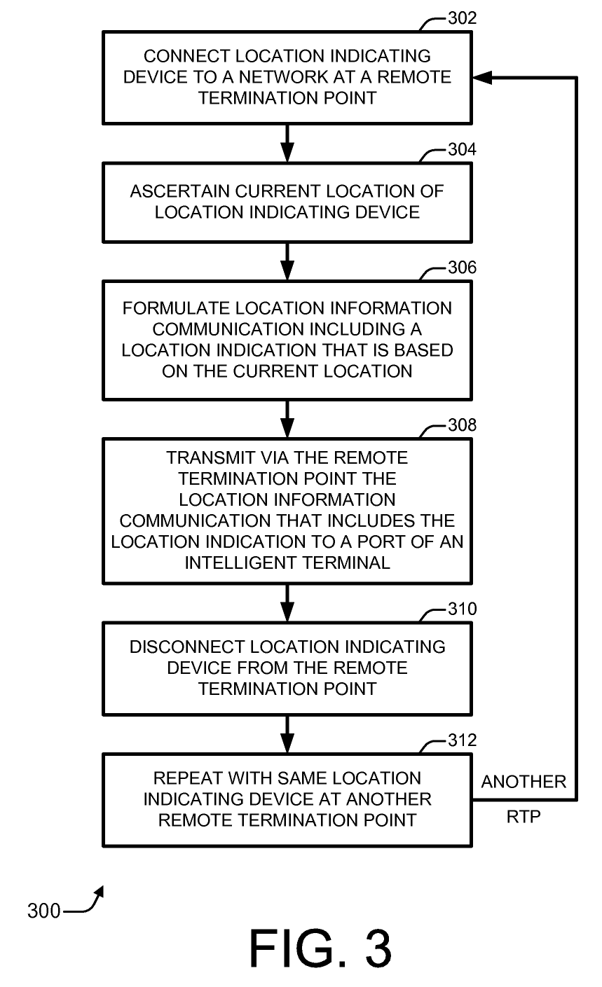

FIG. 3 is a flow diagram 300 that illustrates an example of a general method for port location determination that may be implemented by a location indicating device in conjunction with a human operator. Flow diagram 300 includes six (6) blocks 302-312. Implementations of flow diagram 300 may be realized, for example, as processor-executable instructions that are part of location indicating device 104 (of FIGS. 1 and 2) and/or by operator 210 (of FIG. 2). Example embodiments for this and other methods are further described with reference to elements in other figures of the Drawings.

In an example embodiment, at block 302, a location indicating device is connected to a network at a remote termination point. For example, an operator 210 may connect a location indicating device 104 to a network 108 at an RTP 110a. For position-based location procedures, accuracy can be increased by placing location indicating device 104 proximate to RTP 110a. A location indicating device 104 may be considered proximate to RTP 110a when it is sufficiently close to attain a predetermined desired margin of error. Attaining this proximal distance may be ensured by using a patch cable 118 of sufficiently short length 212. This length 212 may be known by the location determination system of the network and/or may be communicated thereto by location indicating device 104.

At block 304, the current location of the location indicating device is ascertained. For example, the current physical location of location indicating device 104 may be ascertained. For instance, operator 210 may manually input a physical location, or location indicating device 104 may perform an automated process to, e.g. electronically, ascertain the physical location, such as by using a GPS technology to attain GPS coordinates.

At block 306, a location information communication including a location indication that is based on the current location is formulated. For example, location indicating device 104 may formulate location information communication 214 to include location indication 114, which is based on the ascertained current location. Location information communication 214 may be formatted in accordance with any of many existing or new communication protocols. By way of example, location information communication 214 may be formatted in accordance with an IEEE 802.1AB protocol.

At block 308, the location information communication that includes the location indication is transmitted via the remote termination point to a port of an intelligent terminal. For example, location indicating device 104 may transmit location information communication 214 having location indication 114 to a port 208a of an intelligent terminal 102 via RTP 110a. Location information communication 214 may be transmitted over at least one patch cable 118, one or more cablings 116, etc. of network 108. Location information communication 214 may be transmitted in accordance with any of many existing or new communication protocols. By way of example, location information communication 214 may be transmitted in accordance with an IEEE 802.1AB protocol. The transmission communication protocol (for block 308) may be the same as or may differ from the message formatting communication protocol (for block 306).

At block 310, the location indicating device is disconnected from the remote termination point. For example, operator 210 may disconnect location indicating device 104 from RTP 110a. At block 312, the method is repeated with the same location indicating device at another remote termination point. For example, the acts of blocks 302-310 may be repeated by operator 210, starting with connecting location indicating device 104 to another RTP 110, such as RTP 110b.

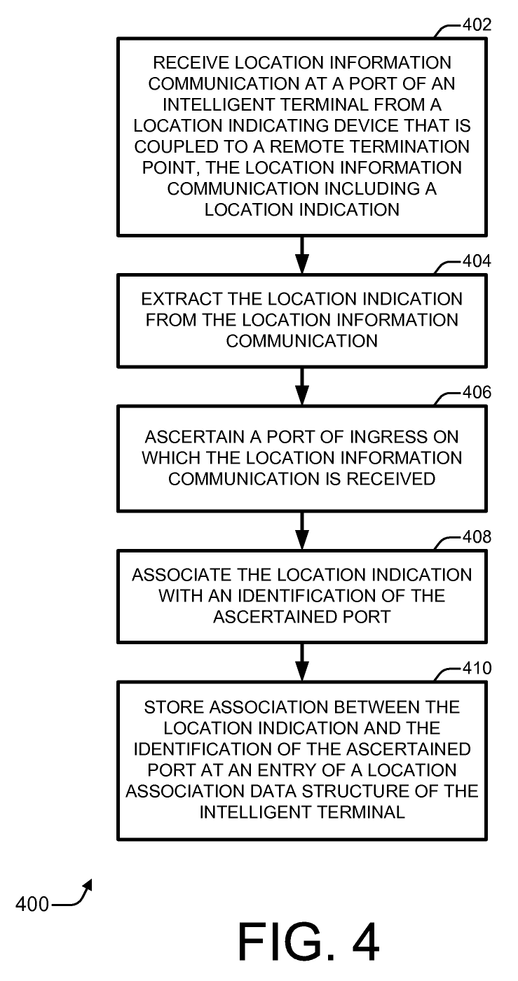

FIG. 4 is a flow diagram 400 that illustrates an example of a general method for port location determination that may be implemented by an intelligent terminal. Flow diagram 400 includes five (5) blocks 402-410.

In an example embodiment, at block 402, a location information communication is received at a port of an intelligent terminal from a location indicating device that is coupled to a remote termination point, the location information communication including a location indication. For example, a location information communication 214 may be received at a port 208a of an intelligent terminal 102 from a location indicating device 104 that is coupled to an RTP 110a, with location information communication 214 including a location indication 114.

Intelligent terminal 102 may receive location information communication 214 via RTP 110a and port 208a over cabling 116 and patch cable 118. Port 208a may be a physical and/or a logical port of intelligent terminal 102. Location indication 114 may be based on a current location of location indicating device 104 as ascertained at the location indicating device.

At block 404, the location indication is extracted from the location information communication. For example, a location association handler 202 of intelligent terminal 102 may extract location indication 114 from location information communication 214. At block 406, the port of ingress on which the location information communication is received is ascertained. For example, location association handler 202 may ascertain that location information communication 214 was received via port 208a.

At block 408, the location indication is associated with an identification of the ascertained port. For example, location indication 114 may be associated with a port ID corresponding to port 208a. At block 410, the association between the location indication and the identification of the ascertained port is stored at an entry of a location association data structure of the intelligent terminal. For example, an association 206 between the extracted location indication 114 and the port ID corresponding to the ascertained arrival port 208a may be stored at an entry 204a of a location association data structure 106 of intelligent terminal 102.

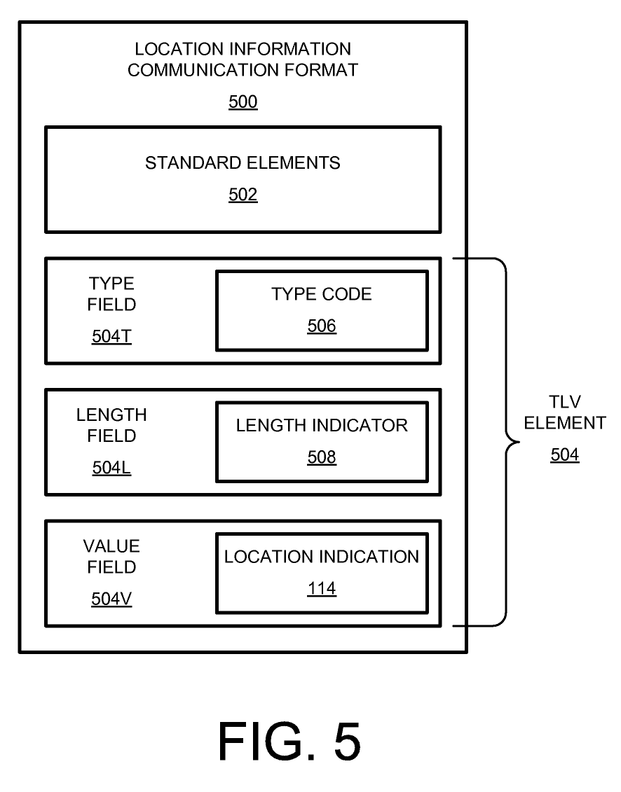

FIG. 5 is a block diagram of an example communication format 500 for a location information communication. As illustrated, location information communication format 500 includes standard elements 502 and a type-length-value (TLV) element 504. TLV element 504 includes three fields: type field 504T, length field 504L, and value field 504V.

Location information communication format 500 may comport with any communications format. However, for an example embodiment, location information communication format 500 comports with an IEEE 802.1AB protocol. Hence, standard elements 502 may be formatted in accordance with standard IEEE 802.1AB elements. IEEE 802.1AB is one example protocol that may be used in conjunction with TLV technology, such as TLV element 504.

Type field 504T includes type code 506. Type code 506 may be an alphanumeric code that indicates the kind of information contained in the TLV element 504 portion of the overall communication. Length field 504L includes a length indicator 508. Length indicator 508 indicates the size of value field 504V, usually in bytes. Value field 504V holds the actual information for TLV element 504. In this example, value field 504V includes location indication 114. Value field 504V may additionally or alternatively include other information, such as length 212 of patch cable 118. Also, although one is explicitly shown, location information communication format 500 may include multiple TLV elements 504.

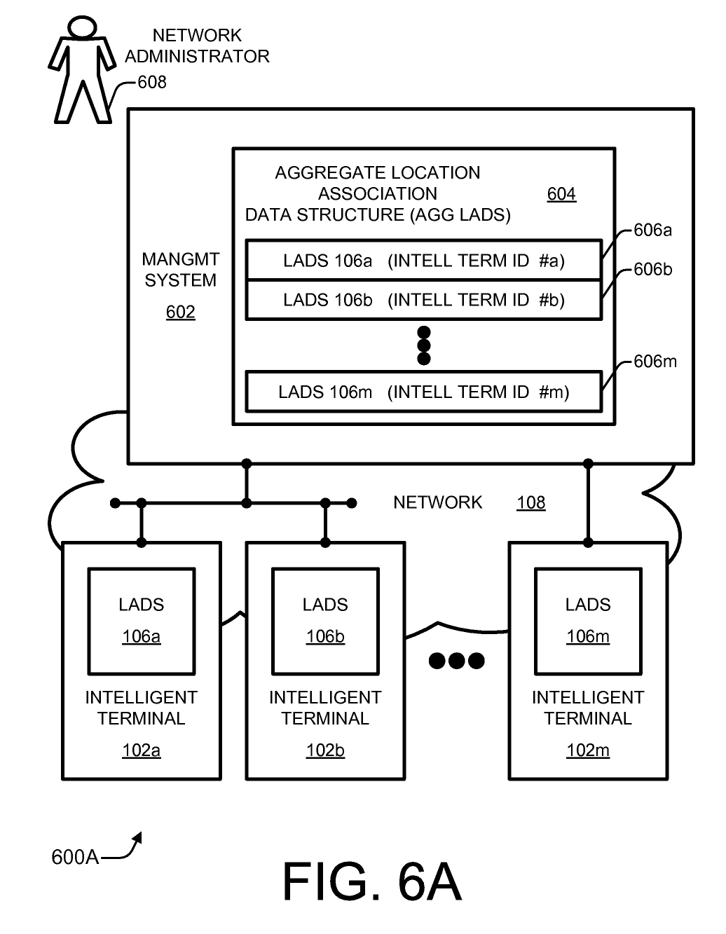

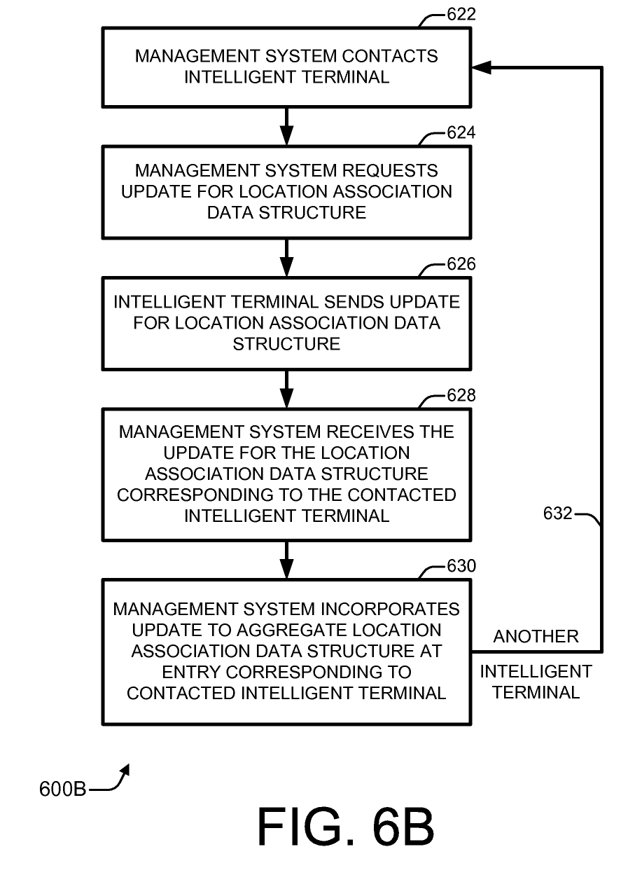

FIGS. 6A and 6B are a block diagram illustrating a scheme 600A and a flow diagram 600B illustrating a method, respectively, for example management system integration embodiments. As illustrated, example scheme 600A includes a management system 602, an aggregate location association data structure 604, and a network administrator 608. Scheme 600A also includes multiple intelligent terminals 102, multiple location association data structures 106, and network 108.

Specifically, “m” intelligent terminals 102 are shown: 102a, 102b . . . 102m, with “m” representing some positive integer. Location association data structures 106a,b,m are respectively disposed as part of intelligent terminals 102a,b,m. Intelligent terminals 102a,b,m are connected with management system 602 via the communication paths of network 108.

In an example embodiment, port location determination using location association data structures 106 is integrated with management system 602. Management system 602 may be controlled by network administrator 608 and may be responsible for monitoring, maintaining, etc. network 108. To facilitate centralized control, a copied version of each location association data structure 106 may be contained within aggregate location association data structure 604.

As illustrated, aggregate location association data structure 604 includes multiple entries 606. Specifically, “m” entries 606 are shown: 606a, 606b . . . 606m. Entries 606a,b,m respectively correspond to location association data structures 106a,b,m of intelligent terminals 102a,b,m. Each respective entry 606 includes a copy of the location association data structure 106 of the corresponding intelligent terminal 102.

Thus, entry 606a includes a copy of location association data structure 106a, which corresponds to intelligent terminal 102a. An identification (ID) of the corresponding intelligent terminal 102, such as intelligent terminal ID #a, may be included in or otherwise correspond to each entry. Thus, entry 606b may include a copy of location association data structure 106b, which corresponds to intelligent terminal 102b, and an intelligent terminal ID #b. Entry 606m may include a copy of location association data structure 106m, which corresponds to intelligent terminal 102m, and an intelligent terminal ID #m. From aggregate location association data structure 604, management system 602 may construct a cross-referenced map of connections to physical locations.

In an example implementation, management system 602 requests updates for location association data structures 106 from intelligent terminals 102. Alternatively, intelligent terminals 102 may push updates of location association data structures 106 to management system 602. Regardless, these control communications between management system 602 and intelligent terminals 102 may be effectuated in accordance with a simple network management protocol (SNMP). To facilitate use of SNMP, each location association data structure 106 may be organized, formatted, etc. in accordance with a management information base (MIB) technology.

With reference to FIG. 6B, example flow diagram 600B includes five (5) blocks 622-630. In an example embodiment, at block 622, a management system contacts an intelligent terminal. For example, management system 602 may contact intelligent terminal 102b.

At block 624, the management system requests an update for the location association data structure from the contacted intelligent terminal. For example, management system 602 may send a message to intelligent terminal 102b, with the message requesting an update for location association data structure 106b. An update may comprise a whole copy of the location association data structure, may comprise those entries that have changed since a last update request, and so forth. At block 626, the intelligent terminal sends the update for its location association data structure. For example, intelligent terminal 102b may send an update for location association data structure 106b.

At block 628, the management system receives the update for the location association data structure corresponding to the contacted intelligent terminal. For example, management system 602 may receive an update for location association data structure 106b from intelligent terminal 102b. The message requests and updates may be sent over network 108 using, e.g., an SNMP.

At block 630, the management system incorporates the update to an aggregate location association data structure at an entry corresponding to the contacted intelligent terminal. For example, management system 602 may incorporate the update of location association data structure 106b to aggregate location association data structure 604 at entry 606b, which corresponds to intelligent terminal 102b. Management system 602 may include an intelligent terminal ID #b at entry 606b or otherwise indicate that entry 606b corresponds to intelligent terminal 102b. As indicated at arrow 632, the management system may request an update from another intelligent terminal.

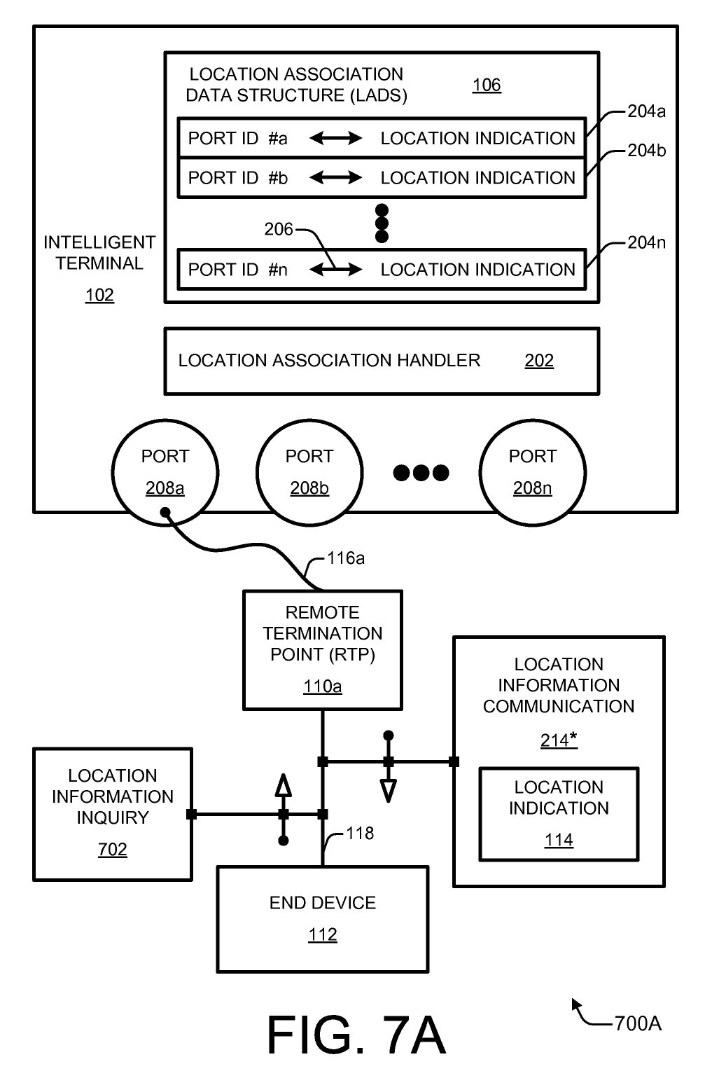

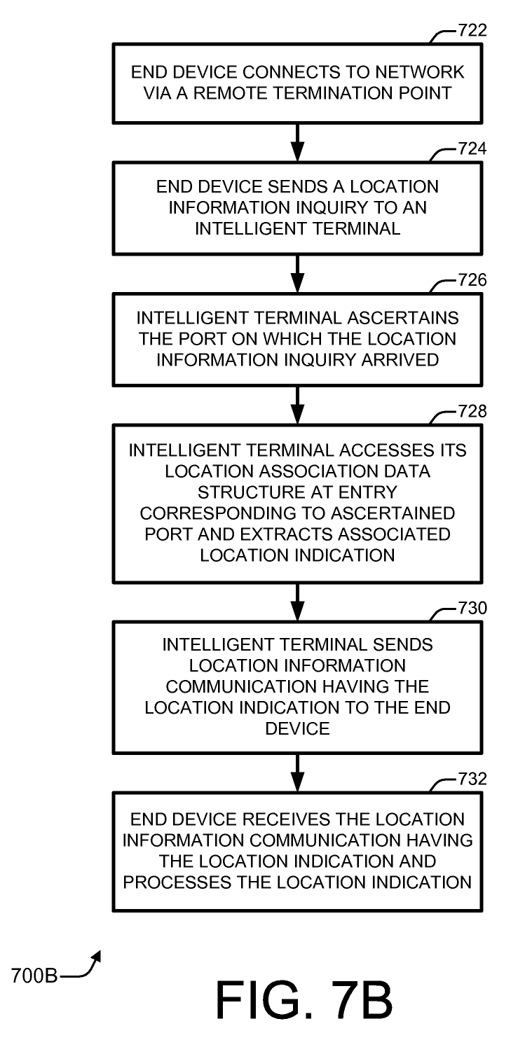

FIGS. 7A and 7B are a block diagram illustrating a scheme 700A and a flow diagram 700B illustrating a method, respectively, for example end device location-indication-acquisition embodiments. As illustrated, in comparison with procedure 200 (of FIG. 2), example scheme 700A adds a location information inquiry 702, attaches an end device 112 to RTP 110a, and modifies location information communication 214*.

In operation of an example embodiment, an end device 112 is coupled to RTP 110a (e.g., after removal of a location indicating device 104). It is given that end device 112 and/or a user thereof wants to know the current location of end device 112, at least in the context of its proximity to RTP 110a. End device 112 sends a location information inquiry 702 to location association handler 202 of intelligent terminal 102 over patch cable 118 and cabling 116a via RTP 110a and port 208a. Location information inquiry 702 may include a reference to location indication data or otherwise indicate that a location is being requested. Location information inquiry 702 may be formatted in accordance with, for example, an IEEE 802.1AB standard.

Location association handler 202 ascertains that location information inquiry 702 arrived via port 208a. Location association handler 202 accesses location association data structure 106 at an entry 204a that corresponds to port 208a and may include a port ID #a. From entry 204a, a location indication 114 that is associated 206 with port 208a is extracted. Location association handler 202 formulates location information communication 214* and includes location indication 114 as a part thereof. Thus, location information communication 214* may contain the same information as location information communication 214 (of FIG. 2), but it is sent from intelligent terminal 102. Also, location information communication 214* may be formatted in accordance with an IEEE 802.1AB standard, for example.

After formulation, intelligent terminal 102 transmits location information communication 214* to end device 112 over cabling 116a and patch cable 118 via port 208a and RTP 110a. End device 112 receives location information communication 214* and extracts location indication 114. End device 112 may then utilize location indication 114. By way of example only, an end device 112 that is a telephone that is connected to RTP 110a may receive an ELIN type of location indication 114 for use with E911 communications.

In these manners, for certain example embodiments, an end device 112 that does not intrinsically possess a location determination capability may nevertheless receive a location indication 114 from an intelligent terminal 102. The location indication 114 corresponds to the RTP 110 to which the end device 112 is coupled.

With reference to FIG. 7B, example flow diagram 700B includes six (6) blocks 722-732. In an example embodiment, at block 722, an end device connects to a network via a remote termination point. For example, end device 112 may connect to network 108 via RTP 110a. At block 724, the end device sends a location information inquiry to an intelligent terminal. For example, end device 112 may send a location information inquiry 702 to intelligent terminal 102. Location information inquiry 702 may include a reference indicating that location information is being requested.

At block 726, the intelligent terminal ascertains the port on which the location information inquiry arrived. For example, a location association handler 202 of intelligent terminal 102 may ascertain that location information inquiry 702 arrived via port 208a. At block 728, the intelligent terminal accesses its location association data structure at an entry corresponding to the ascertained port and extracts an associated location indication. For example, location association handler 202 may access location association data structure 106 at entry 204a, which corresponds to port 208a, and may extract the associated location indication.

At block 730, the intelligent terminal sends a location information communication having the location indication to the end device. For example, intelligent terminal 102 may send location information communication 214* having a location indication 114 to end device 112. At block 732, the end device receives the location information communication having the location indication and processes the location indication. For example, end device 112 may receive location information communication 214* and appropriately process location indication 114.

The acts of the various flow diagrams that are described herein may be performed in many different environments and with a variety of different devices, such as by one or more processing devices (of FIG. 8). The orders in which the methods are described are not intended to be construed as a limitation, and any number of the described blocks can be combined, augmented, rearranged, and/or omitted to implement a respective method, or an alternative method that is equivalent thereto. Also, although specific elements of other figures are referenced in the description of the flow diagrams, the methods may be performed with alternative elements.

FIG. 8 is a block diagram 800 of example devices 802 that may be used to implement embodiments for port location determination. As illustrated, block diagram 800 includes two devices 802(1) and 802(2), network 108, and human-device interface equipment 812. As explicitly shown with device 802(1), each device 802 may include at least one processor 804, one or more media 806, one or more input/output interfaces 808, and at least one interconnection 814. Media 806 may include processor-executable instructions 810.

For example embodiments, device 802 may represent any processing-capable device. Processor 804 may be implemented using any applicable processing-capable technology, and one may be realized as a general-purpose or a special-purpose processor. Media 806 may be any available media that is included as part of and/or is accessible by device 802. It includes volatile and non-volatile media, removable and non-removable media, storage and transmission media (e.g., wireless or wired communication channels), hard-coded logic media, combinations thereof, and so forth. Media 806 is tangible media when it is embodied as a manufacture and/or as a composition of matter.

Interconnection 814 interconnects the components of device 802. Interconnection 814 may be realized as a bus or other connection mechanism and may directly or indirectly interconnect various components. I/O interfaces 808 may include (i) a network interface for monitoring and/or communicating across network 108, (ii) a display device interface for displaying information on a display screen, (iii) one or more human-device interfaces, and so forth. Human-device interface equipment 812 may be a keyboard/keypad, a touch screen, a remote, a mouse or other graphical pointing device, a screen, a speaker, and so forth.

Network(s) 108 may be, by way of example but not limitation, an internet, an intranet, an Ethernet, a public network, a private network, a cable network, a digital subscriber line (DSL) network, a telephone network, a wireless network, some combination thereof, and so forth. Device 802(1) and device 802(2) may communicate over network(s) 108.

Generally, processor 804 is capable of executing, performing, and/or otherwise effectuating processor-executable instructions, such as processor-executable instructions 810. Media 806 is comprised of one or more processor-accessible media. In other words, media 806 may include processor-executable instructions 810 that are executable by processor 804 to effectuate the performance of functions by device 802. Processor-executable instructions 810 may be embodied as software, firmware, hardware, fixed logic circuitry, some combination thereof, and so forth.

In example implementations, one device 802 may comprise an intelligent terminal 102, and another device 802 may comprise a location indicating device 104 (or end device 112). Processor-executable instructions 810 may comprise location association handler 202, location association data structure 106, location information communication 214, aggregate location association data structure 604, and so forth. When processor-executable instructions 810 are executed by processor 804, the functions that are described herein may be effectuated. Example functions include, but are not limited to, those illustrated by flow diagrams 300, 400, 600B, and 700B and those pertaining to features illustrated by the various procedures, schemes, and so forth.

The devices, acts, features, functions, methods, schemes, data structures, procedures, components, etc. of FIGS. 1-8 are illustrated in diagrams that are divided into multiple blocks and other elements. However, the order, interconnections, interrelationships, layout, etc. in which FIGS. 1-8 are described and/or shown are not intended to be construed as a limitation, and any number of the blocks and/or other elements can be modified, combined, rearranged, augmented, omitted, etc. in any manner to implement one or more systems, methods, devices, media, apparatuses, arrangements, etc. for port location determination for wired intelligent terminals.

Although systems, methods, devices, media, apparatuses, arrangements, and other example embodiments have been described in language specific to structural, logical, algorithmic, and/or functional features, it is to be understood that the invention defined in the appended claims is not necessarily limited to the specific features or acts described above. Rather, the specific features and acts described above are disclosed as example forms of implementing the claimed invention.

What is claimed is:

1. An intelligent terminal device for port location determination, the intelligent terminal device comprising:
multiple ports that provide points of ingress and egress for communications being received at and transmitted from the intelligent terminal device;
a location association data structure including multiple entries, each entry of the multiple entries corresponding to a respective port of the multiple ports; each entry capable of associating a port identification of the corresponding respective port with a location indication; and
a location association handler to ascertain a port of the multiple ports on which a location information communication is received from a location indicating device coupled to a remote termination point, the location information communication including a particular location indication that is ascertained at the location indicating device; the location association handler to store the particular location indication in association with a port identification of the ascertained port in the location association data structure at an entry of the multiple entries that corresponds to the ascertained port.

2. The intelligent terminal device as recited in claim 1, wherein the intelligent terminal device comprises network equipment and a non-intelligent patch panel; and wherein the network equipment comprises the multiple ports, the location association data structure, and the location association handler.

3. The intelligent terminal device as recited in claim 1, wherein the intelligent terminal device comprises network equipment and an intelligent patch panel; and wherein the network equipment comprises the multiple ports, and the intelligent patch panel comprises the location association data structure and the location association handler.

4. The intelligent terminal device as recited in claim 1, wherein the location association handler is to organize the location association data structure in accordance with management information base (MIB) technology that enables access to the location association data structure using a simple network management protocol (SNMP).

5. The intelligent terminal device as recited in claim 1, wherein the location association handler is adapted to process communications that comport with an IEEE 802.1AB standard; and wherein the location information communication comports with the IEEE 802.1AB standard.

6. The intelligent terminal device as recited in claim 1, wherein the intelligent terminal device, in response to receipt of an update request from a management system, is to send an update for the location association data structure to the management system.

7. The intelligent terminal device as recited in claim 1, wherein the location association handler, in response to receipt by the intelligent terminal device of a location information inquiry from an end device via the ascertained port corresponding to the port identification that is associated with the particular location indication, is to send a location information communication having the particular location indication to the end device, the end device coupled to the remote termination point.

8. The intelligent terminal device as recited in claim 1, further comprising:
at least one processor; and
one or more media that include processor-executable instructions and are operatively coupled to the at least one processor, the processor-executable instructions comprising the location association data structure and the location association handler; wherein the location association handler performs the ascertaining and the storing when the at least one processor executes the processor-executable instructions.

9. The intelligent terminal device as recited in claim 1, wherein the entry that corresponds to the ascertained port and stores the particular location indication includes the port identification of the ascertained port.

10. A method for port location determination with an intelligent terminal, the method comprising acts of:
receiving a location information communication via a port of the intelligent terminal from a location indicating device that is coupled to a remote termination point, the location information communication including a location indication;
extracting the location indication from the location information communication;
ascertaining the port on which the location information communication is received;
associating the location indication with an identification of the ascertained port; and
storing the location indication in association with the identification of the ascertained port in an entry of a location association data structure of the intelligent terminal, the entry corresponding to the ascertained port.

11. The method as recited in claim 10, wherein the act of extracting comprises:
extracting the location indication from a value field of a type-length-value element of the location information communication.

12. The method as recited in claim 10, further comprising:
receiving from a management system a request for an update for the location association data structure; and
sending the update for the location association data structure to the management system.

13. The method as recited in claim 12, wherein the method for port location determination is further performed at least partially by the management system, the method further comprising acts of:
sending, by the management system, the request for the update for the location association data structure to the intelligent terminal;
receiving, by the management system, the update for the location association data structure from the intelligent terminal; and
incorporating, by the management system, the update for the location association data structure into an aggregate location association data structure at an entry corresponding to the intelligent terminal, the aggregate location association data structure including updates for location association data structures from other intelligent terminals.

14. The method as recited in claim 10, further comprising:
receiving via the port at the intelligent terminal a location information inquiry from an end device that is coupled to the remote termination point;
ascertaining the port on which the location information inquiry is received;
accessing the location association data structure at the entry corresponding to the ascertained port;
extracting the location indication that is stored at the accessed entry corresponding to the ascertained port;
formulating at the intelligent terminal a location information communication that includes the location indication; and
sending the location information communication having the location indication to the end device via the port and the remote termination point.

15. The method as recited in claim 10, wherein the location indication comprises geographical information, building information, a jack identifier, elevation information, an emergency location information number (ELIN), or a specific description.

16. A method for port location determination with a location indicating device, the method comprising acts of:
connecting the location indicating device to a network at a remote termination point;
ascertaining a current location of the location indicating device;
formulating a location information communication including a location indication that is based on the current location; and
transmitting via the remote termination point the location information communication that includes the location indication to a port of an intelligent terminal that forms part of the network.

17. The method as recited in claim 16, further comprising:
disconnecting the location indicating device from the remote termination point; and
repeating the acts of connecting, ascertaining, formulating, and transmitting with the location indicating device at multiple other remote termination points.

18. The method as recited in claim 16, wherein the act of ascertaining comprises:
electronically determining current positional location information; or
manually inputting current location information.

19. The method as recited in claim 16, wherein the method for port location determination is further performed at least partially with the intelligent terminal, the method further comprising acts of:
receiving via the port at the intelligent terminal the location information communication from the location indicating device;
extracting, by the intelligent terminal, the location indication from the location information communication;
ascertaining, by the intelligent terminal, the port on which the location information communication is received;
associating, by the intelligent terminal, the location indication with an identification of the ascertained port; and
storing, by the intelligent terminal, the location indication in association with the identification of the ascertained port in an entry of a location association data structure of the intelligent terminal, the entry corresponding to the ascertained port.

20. The method as recited in claim 19, wherein:
the act of transmitting comprises transmitting the location information communication over a patch cable that couples the location indicating device to the remote termination point; and
the act of receiving comprises receiving the location information communication over cabling that couples the remote termination point to the port of the intelligent terminal.
